(19) United States
(12) Patent Application Publication
(10) Pub. No.: US 2021/0280346 A1
(43) Pub. Date: Sep. 9, 2021

(54) SEMI-HARD MAGNETIC ALLOY FOR AN ACTIVATION STRIP, DISPLAY ELEMENT, AND METHOD FOR PRODUCING A SEMI-HARD MAGNETIC ALLOY

(71) Applicant: Vacuumschmelze GmbH & Co. KG, Hanau (DE)

(72) Inventors: Ottmar ROTH, Gründau (DE); Alberto BRACCHI, Hanau (DE)

(21) Appl. No.: 16/461,347

(22) PCT Filed: Nov. 15, 2017
(86) PCT No.: PCT/EP2017/079344

§ 371 Date: May 15, 2019

(30) Foreign Application Priority Data
Nov. 18, 2016 (DE) 10 2016 222 781.5

(51) Int. Cl. H01F 1/147; G08B 13/24; C22C 38/04; C22C 38/06; C22C 38/08; C22C 38/14; C22C 38/16

(52) U.S. Cl. CPC H01F 1/14708; G08B 13/2442; C22C 38/04; C22C 38/16; C22C 38/08; C22C 38/14; C22C 38/06

(57) ABSTRACT

A semi-hard magnetic alloy for activation strips in magnetic anti-theft systems is provided. The alloy consists essentially of 5 to 15 wt % Ni, 0.5 to 8 wt % Mn, 0.2 to 4 wt % Cu, 0 to 2 wt % Ai, 0 to 2 wt % Ti, the remainder iron and up to 1 wt % impurities, where 0.5 wt %<(Cu+Al+Ti)<5 wt %.

This application is a 371 national phase entry of PCT/EP2017/079344 filed on 15 Nov. 2017, which claims benefit of German Patent Application No. 10 2016 222 781.5, filed 18 Nov. 2016, the entire contents of which are incorporated herein by reference for all purposes.

### BACKGROUND

### 1. Technical Field

The invention relates to a semi-hard magnetic alloy for an activation strip in a magnetic anti-theft system, a display element for a magnetic anti-theft system and a method for producing a semi-hard magnetic alloy for an activation strip.

### 2. Related Art

Magnetic anti-theft systems and display elements are known from EP 0 121 649 B1 and U.S. Pat. No. 5,729,200, for example. The display element includes at least one amorphous ferromagnetic alarm strip and at least one semi-hard magnetic activation strip. In these anti-theft systems, a detector system emits an impulse that excites the alarm strip of the display element such that the alarm strip oscillates with a characteristic resonance frequency. The detector system thereby recognises the alarm strip and triggers an alarm.

In magnetoelastic systems, the activation strip serves to activate the alarm strip by means of magnetisation. In these systems, the alarm strip oscillates with a characteristic resonance frequency while the activation strip is being magnetised. The alarm strip is deactivated by the change in its resonance frequency. This is achieved by demagnetising the semi-hard magnetic activation strip such that the display element oscillates at another frequency and is not recognised by the detector system.

The display elements can be provided in the form of a label that is applied to an object or inserted directly in or onto the object to be protected, so-called source tagging.

A semi-hard magnetic alloy suitable for use as an activation strip in a magnetic anti-theft system is disclosed in DE 197 32 872 A1, for example. This alloy contains 8 to 25 wt % nickel, 0.5 to 3 wt % titanium, 1.5 to 4.5 wt % aluminium and the remainder iron. The display element should be reliably recognised by the system when activated and likewise reliably not recognised when not activated. This requirement determines the magnetic properties of the materials of the activation strip and the alarm strip. So that semi-hard magnetic alloys can also be magnetised from a greater distance or with smaller fields, the coercitivity Hₑ is limited to values of no more than 30 A/cm. To achieve adequate opposing field stability, the lower limit value of coercitivity Hₑ is fixed at 10 A/cm.

In order to broaden the field of application of display elements it is, however, desirable to reduce production costs, though without compromising the reliability of the detection process.

### SUMMARY

The object of the invention is, therefore, to provide alternative semi-hard magnetic alloys for an activation strip of a display element that both fulfil the requirements set out above and can be produced cost effectively.

The object is achieved by means of the subject-matter of the independent claims. Advantageous developments are detailed in the associated dependent claims.

A semi-hard magnetic alloy for activation strips in magnetic anti-theft systems is provided and consists essentially of 5 to 15 wt % (weightpercent) Ni, 0.5 to 8 wt % Mn, 0.2 to 4 wt % Cu, 0 to 2 wt % Al, 0 to 2 wt % Ti and the remainder iron as well as up to 1 wt % impurities, where 0.5 wt %<(Cu+Al+Ti)<5 wt %.

At least one of the elements C, N, S, P, B, H and O may be present as impurities in individual percentages of less than 0.2 wt % of the alloy und in a total percentage of less than 1 wt % of the alloy.

The term ‘semi-hard magnetic’ alloy is used here to refer to a magnetic alloy with semi-hard magnetic properties, these semi-hard magnetic properties being defined here as a coercitivity H_{c} in the region of approx. 7 A/cm to 400 A/cm and a remanence Br, after removal of a constant magnetising field that substantially magnetises the alloy to saturation, of approx. 0.6 T or greater.

In this alloy, the nickel content is therefore partially replaced by Mn. This has the advantage of reducing the raw materials costs. Furthermore, it is possible to reach comparable remanence values Bᵣₘₐₓ and H_{c}, making the alloy suitable for use as an activation strip in an anti-theft system. Suitable values are a remanence Br of 1.3 T to 1.7 T and a coercive force H_{c} of 10 to 30 A/cm. The alloy can, for example, have a coercive force H_{c} of 10 to 24 A/cm and a remanence Br of at least 1.3 T (13,000 Gaus) to 1.7 T. Furthermore, the aluminium content and/or the titanium content can be replaced partially or entirely by Cu to avoid the formation of deposits of Al- and Ti-rich phases during the melting and solidifying process and during the various heat treatment processes. This has the advantage of making the alloy simpler to produce and to process.

The alloys according to the invention are highly ductile and cold-formable prior to tempering (final annealing) so that reductions in cross-section of over 90% are possible. Such alloys can be used, in particular by means of cold rolling, to produce strips with thicknesses of less than 0.05 mm.

In other exemplary embodiments, the copper content lies between 1.5 wt % and 2.75 wt % and/or the nickel content lies between 7 wt % and 10 wt % and/or the manganese content lies between 4 wt % and 6 wt %. The sum of elements Ni and Mn can be defined more accurately as 12 wt %<(Ni+Mn)<15 wt %.

In one exemplary embodiment Al and Ti are completely replaced by Cu such that the sum of the manganese and nickel contents lies between 13.5 wt % and 14.5 wt %, the copper content lies between 2.75 wt % and 3.25 wt %, the aluminium content is less than 0.1 wt % and the titanium content is less than 0.1 wt %.

The invention also relates to a display element for use in a magnetic anti-theft system comprising at least one elongated alarm strip that consists of an amorphous ferromagnetic alloy and at least one activation strip that consists of a semi-hard magnetic alloy according to the invention.

The invention also provides for a label with a display element having an activation strip made of a semi-hard magnetic alloy according to the invention. The label can have a housing that covers or sheaths the display element. In a further exemplary embodiment a layer of adhesive is arranged on at least one side of the housing. As a result, the label can be stuck easily to an object to be protected.

The Invention also provides for an object, such as a consumer product, for example, e.g. a consumer product to be sold or a label with a display element according to any of the exemplary embodiments described above. The display element can be integrated into or fixed onto the object. The display element can be fixed to the object in the form of a label.

A further exemplary embodiment provides for packaging for a consumer object having a display element according to any of the exemplary embodiments described above. The packaging can be further processed at the product manufacturers in order to form a container, for example. In a further step the content can be introduced into the packaging with a display element already provided.

A method for producing a semi-hard magnetic alloy for activation strips in magnetic anti-theft systems is also disclosed. An alloy is melted in a vacuum or a protective gas and then cast into an ingot, the alloy consisting essentially of 5 to 15 wt % Ni, 0.5 to 8 wt % Mn, 0.2 to 4 wt % Cu, 0 to 2 wt % Al, 0 to 2 wt % Ti, the remainder iron and up to 1 wt % impurities, where 0.5 wt %<(Cu+Al+Ti)<5 wt %. The ingot is hot-formed into a strip at temperatures of between 800° C. and 1300° C., the strip undergoes intermediate annealing at a temperature greater than approx. 800° C. and is then cooled rapidly, for example quenched. The strip is then cold-formed to achieve a reduction in cross-section of approx. 90%, undergoes intermediate annealing at a temperature of between 600° C. and 800° C., is cold-formed to achieve a reduction in cross-section of at least 85% and then heat-treated at a temperature of 350° C. to 500° C.

The duration of the intermediate annealing and the tempering can be at least 3 hours.

In one exemplary embodiment the ingot is hot-formed into a strip at temperatures of above approx. 800° C., the strip undergoes intermediate annealing at a temperature of above approx. 800° C. and cooled rapidly, e.g. at a speed greater than 500K/min. The strip is then cold-formed to achieve a reduction in cross-section of approx. 90%, undergoes intermediate annealing at approx. 700° C., cold-formed to achieve a reduction in cross-section of at least 85% and then heat treated at a temperature of approx. 450° C. to approx. 480° C. or of approx. 480° C.

The strip can then be cut up in order to produce a plurality of narrower strips from one wider strip. One or typically a plurality of activation strips can be cut to length from the strip.

The magnetic values of the alloy can be set by a combination of cold-forming and heat treatment. At above approx. 600° C. it exhibits a austenitic structure. At room temperature, on the other hand, the alloy is martensitic. Owing to the intensive cold-forming after intermediate annealing at approx. 700° C. and subsequent heat treatment at approx. 480° C., strong anisotropy develops in the direction of rolling (i.e. in the longitudinal direction of the strip), thereby achieving the optimum permanent magnetic properties and a strong rectangularity of the hysteresis loop for the alloy. The typical magnetic properties exhibit a coercitivity of between 10 A/cm and 30 A/cm or between 10 A/cm and 22 A/cm and a remanence of between 1.3 T and 1.70 T or between 1.30 T and 1.60 T.

The alloys according to the invention are typically produced by casting a molten material consisting of alloy components in a crucible or furnace in a vacuum or a protective gas atmosphere. The temperatures at which the process takes place are approx. 1600° C.

Casting typically takes place in a round mould. Cast bars made from these alloys are then typically processed by means of hot-forming, preferably at temperatures of above 800° C., intermediate annealing, cold-forming and further intermediate annealing. The intermediate annealing is carried out for the purposes of homogenisation, grain refinement, deformation or the formation of desirable mechanical properties, in particular high ductility.

Tempering temperatures can be 400° C. to 600° C. or 350° C. to 550° C. and tempering times can typically be one minute to 24 hours. The alloys according to the invention can, in particular, be cold-formed to achieve a reduction in cross-section of at least 60% prior to tempering. The tempering step increases the coercive force and the rectangularity of the magnetic B-H-loop and is important, in some cases essential, in terms of the requirements placed on magnetic bias strips.

A method for producing a display element for a magnetic anti-theft system is also disclosed. At least one elongated alarm strip consisting of an amorphous ferromagnetic alloy and at least one elongated activation strip consisting of a semi-hard magnetic alloy according to any of the preceding exemplary embodiments are provided. At least one alarm strip is arranged on at least one activation strip in order to produce a display element.

The alarm strip and the activation strip of the display element can be arranged in a housing or in the packaging of a consumer object.

Exemplary embodiments are explained in greater detail below with reference to the attached drawings and the examples set out

### BRIEF DESCRIPTION OF THE DRAWINGS

FIG. 1 shows a display element for a magnetic anti-theft system.

FIG. 2 shows a graph of magnetic properties of alloys according to the invention and comparative examples.

Table 1 shows the composition and magnetic properties of alloys according to the invention and comparative examples.

Table 2 shows the composition and magnetic properties of alloys according to the invention.

### DETAILED DESCRIPTION OF EXAMPLE EMBODIMENTS

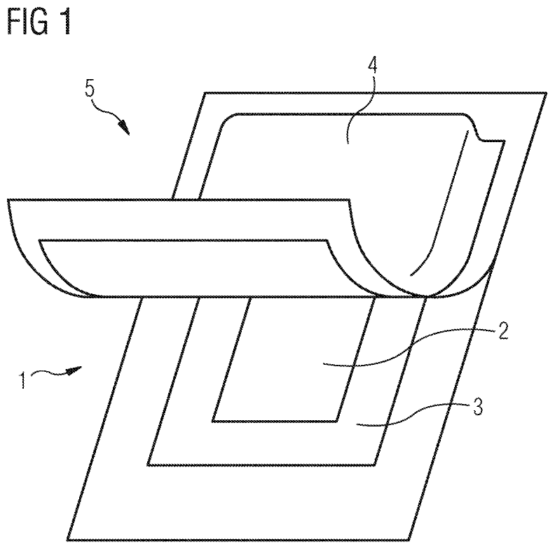

FIG. 1 shows a display element 1 consisting of an alarm strip 2 and an activation strip 3. A large-area side of the alarm strip 2 is arranged on a large-area side of the activation strip 3 so as to form a stack. The alarm strip 2 consists of an amorphous ferromagnetic alloy and the activation strip 3 consists of a semi-hard magnetic alloy according to one exemplary embodiment of the invention.

In the object shown in FIG. 1, the display element 1 is arranged in a housing 4 made of plastic that has the shape of a label 5. In further exemplary embodiments (not illustrated) the housing 4 is an object, a consumer object or the packaging for a consumer object. In further exemplary embodiments (also not illustrated) the label 5 is arranged on a further object such as a consumer object, for example fixed on the object by means of an adhesive layer.

This exemplary embodiment provides for a display element for use in a magnetoelastic anti-theft system. Consequently, the activation strip 3 is magnetised in order to activate the alarm strip 2. The alarm strip 2 oscillates when excited in a detector system (not shown) with a characteristic resonance frequency that is recognised by the detector system as a display element.

The activation strip 3 consists of a semi-hard magnetic alloy with 5 to 15 wt % Ni, 0.5 to 8 wt % Mn, 0.2 to 4 wt % Cu, 0 to 2 wt % Al, 0 to 2 wt % Ti, the remainder iron and up to 1 wt % of impurities, where 0.5 wt %<(Cu+Al+Ti)<5 wt %, and can take the form of a thin strip with a thickness of e.g. 50 μm.

The activation strip production process consists of melting the semi-hard magnetic alloy at, for example, 1600° C., hot rolling the blocks into slabs at temperatures of above 800° C. and from there into hot strips with a thickness of approx. 3 mm with subsequent heat treatment at temperatures of above 800° C. with quenching. After initial cold-forming comes intermediate annealing at a thickness of approx. 0.25 mm and approx. 700° C., followed by a second cold-forming to the final thickness and finally a tempering treatment at approx. 480° C.

Table 1 indicates the compositions and measured magnetic properties of various samples. It also gives the martensite-austenite conversion temperature (Conv.) and the austenite-martensite reconversion temperature (Reconv.). Comparative examples are indicated by an *.

TABLE 1

| | Ni | Mn | Al | Ti | Cu | Fe | Conv. | Reconv. | Br max. | Hc |
|---|---|---|---|---|---|---|---|---|---|---|
| Charge | (wt %) | (wt %) | (wt %) | (wt %) | (wt %) | (wt %) | (° C.) | (° C.) | (T) | (A/cm) |
| 81-0616* | 13.90 | | 1.68 | 0.74 | | Rest | 695 | 412 | 1.56 | 13.5 |
| 81-0624* | 8.95 | 4.01 | 1.45 | 1.68 | | Rest | 710 | 330 | 1.54 | 18.6 |
| 81-0622* | 8.95 | 4.01 | 1.44 | 0.72 | | Rest | 700 | 337 | 1.50 | 13.0 |
| 81-0618* | 9.11 | 3.99 | 0.41 | 1.75 | | Rest | 668 | 320 | 1.39 | 17.4 |
| 81-0623* | 8.98 | 4.02 | 0.47 | 0.70 | | Rest | 657 | 334 | 1.37 | 16.0 |
| 81-0617* | 6.99 | 6.02 | 0.86 | 1.25 | | Rest | 674 | 294 | 1.47 | 17.3 |
| 81-0626 | 6.95 | 5.97 | | | 2.57 | Rest | 590 | 240 | 1.50 | 13.6 |

TABLE 2

| | Ni | Mn | Al | Ti | Cu | Fe | Conv. | Re-conv. | B_{R} max. | H_{C} |
|---|---|---|---|---|---|---|---|---|---|---|
| Charge | (wt %) | (wt %) | (wt %) | (wt %) | (wt %) | (wt %) | (° C.) | (° C.) | (T) | (A/cm) |
| 93-0270 | 7.03 | 5.99 | | | 2.08 | Rest | 605 | 243 | 1.48 | 15.7 |
| 93-0271 | 6.99 | 5.99 | | | 2.59 | Rest | 589 | 262 | 1.50 | 13.8 |
| 93-0272 | 7.03 | 5.99 | | | 3.14 | Rest | 595 | 245 | 1.52 | 16.0 |
| 93-0273 | 6.53 | 5.49 | | | 2.61 | Rest | 605 | 285 | 1.51 | 12.6 |
| 93-0274 | 6.53 | 6.49 | | | 2.62 | Rest | 600 | 239 | 1.48 | 14.5 |
| 93-0275 | 7.53 | 6.47 | | | 2.62 | Rest | 582 | 214 | 1.51 | 16.5 |
| 93-0276 | 7.44 | 5.43 | | | 2.55 | Rest | 616 | 240 | 1.51 | 13.2 |
| 93-0277 | 6.98 | 5.96 | 0.92 | 0.71 | 2.52 | Rest | 651 | 276 | 1.47 | 14.0 |
| 93-0278 | 6.98 | 5.87 | 1.73 | 0.73 | 2.48 | Rest | 675 | 285 | 1.46 | 16.2 |
| 93-0279 | 6.99 | 5.99 | 1.34 | 0.52 | 2.51 | Rest | 656 | 281 | 1.46 | 17.2 |
| 93-0280 | 7.00 | 6.01 | 1.35 | 0.94 | 2.49 | Rest | 661 | 282 | 1.44 | 17.1 |

Comparative example 81-0616 represents an alloy that is commercially available under the trade name SENSORVAC. This alloy has 13.90 wt % Ni, 1.68 wt % Al, 0.74 wt % Ti and the rest iron and has a remanence Bᵣₘₐₓ of 1.56 T and a coercitivity H_{c} of 13.5 A/cm.

In comparative examples 81-0624, 81-0622, 81-0618, 81-0623 and 81-0617 nickel is partially replaced by manganese and the aluminium and titanium contents vary. In alloy 81-0627 according to the invention Al and Ti are completely replaced by copper, giving the alloy a composition of 6.95 wt % Ni, 5.97 wt % Mn, 2.57 wt % Cu and the rest iron. It has a remanence Bᵣₘₐₓ of 1.50 T and a coercitivity H_{c} of 13.6 A/cm and consequently magnetic properties that make it suitable for use as an activation strip in a display element.

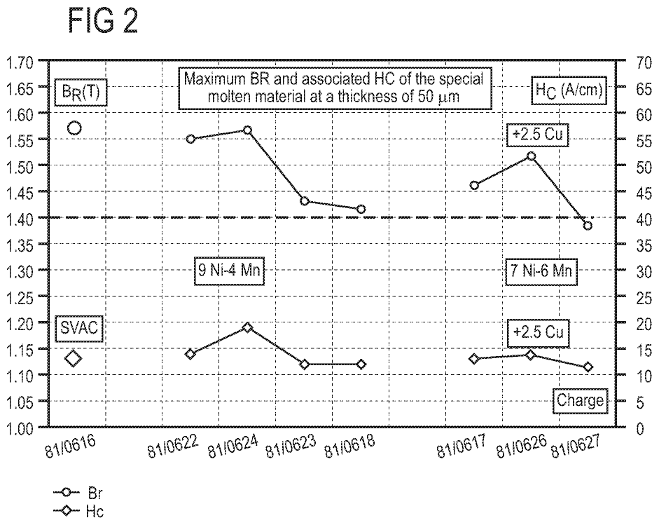

FIG. 2 summarises the magnetic results of the examples. As can be seen, magnetic values comparable to the alloy Fe_{Rest}Ni₁₄Al₂Ti₁ are reached if, instead of 14 wt % Ni, the nickel in the alloy is partially replaced by manganese, e.g. if 9 wt % Ni and 4 wt % Mn are used (see examples 81/0616 to 81/0622 and 81/0624). Similarly, results similar to those reached with the addition of Al and Ti are reached with the addition of Cu (see examples 81/0626 to 81/0617).

Table 2 shows further examples according to the invention. An alloy with the composition indicated in Table 2 is melted in a vacuum or a protective gas and then cast into an ingot. The ingot is hot-formed into a strip at temperatures of above approx. 800° C., then undergoes intermediate annealing at a temperature of above approx. 800° C. and rapid cooling, e.g. quenching. The strip is then cold-formed to achieve a reduction in cross-section of approx. 90%, undergoes intermediate annealing at approx. 700° C., is cold-formed to achieve a reduction in cross-section of at least 85% and then heat treated at a temperature of approx. 450° C.

Examples 93-0270, 93-0271, 93-0272, 93-0273, 93-0274, 93-0275 and 93-0276 each feature Cu in addition to Ni, Mn and Fe and an absence of both Al and Ti. Examples 93-0277, 93-0278, 93-0279 and 93-0280 feature Cu, Al and Ti in addition to Ni, Mn and Fe. In all the examples given in Table 2, the nickel content is below 7.5 wt %.

In addition, the martensite-austenite conversion temperature (Conv.) and the austenite-martensite reconversion temperature (Reconv.) are also indicated in Table 2.

All the examples in Table 2 have a remanence Bᵣₘₐₓ of at least 1.44 T and a coercitivity H_{c} of at least 12.6 A/cm and, as such, magnetic properties that are suitable for an activation strip in a display element.

As a result, on one hand, the Ni content can be reduced, leading to a reduction in cost of the alloy. On the other, the addition of Cu to partially or completely replace Al and/or Ti makes a new family of alloys conceivable for this application.

1. A semi-hard magnetic alloy for an activation strip in magnetic anti-theft systems consisting essentially of 5 to 15 wt % Ni, 0.5 to 8 wt % Mn, 0.2 to 4 wt % Cu, 0 to 2 wt % Al, 0 to 2 wt % Ti, the rest iron and up to 1 wt % impurities, where 0.5 wt %<(Cu+Al+Ti)<5 wt %.

2. A semi-hard magnetic alloy according to claim 1, wherein the copper content lies between 1.5 wt % and 2.75 wt %.

3. A semi-hard magnetic alloy according to claim 1, wherein the nickel content lies between 7 wt % and 10 wt %.

4. A semi-hard magnetic alloy according to claim 1, wherein the manganese content lies between 4 wt % and 6 wt %.

5. A semi-hard magnetic alloy according to claim 1, where 12 wt %<(Ni+Mn)<15 wt %.

6. A semi-hard magnetic alloy according to claim 1, wherein the sum of the manganese and nickel contents lies between 13.5 wt % and 14.5 wt %, the copper content lies between 2.75 wt % and 3.25 wt %, the aluminium content is less than 0.1 wt % and the titanium content is less than 0.1 wt %.

7. A display element for use in a magnetic anti-theft system comprising:
at least one elongated alarm strip comprising an amorphous ferromagnetic alloy, and
at least one activation strip made of a semi-hard magnetic alloy according to claim 1.

8. An object having a display element according to claim 7.

9. An object according to claim 8, the object being a label.

10. An object according to claim 9, wherein the label has a housing that sheathes the display element.

11. An object according to claim 10, wherein a layer of adhesive is arranged on at least one side of the housing.

12. A consumer object with a label having a display element according to claim 7.

13. A consumer object according to claim 12, wherein the label comprises a housing that sheathes the display element.

14. A consumer object according to claim 13, wherein a layer of adhesive, by means of which the label is fixed to the consumer object, is arranged on at least one side of the housing.

15. A packaging for a consumer object having a display element according to claim 7.

16. A method for producing a semi-hard magnetic alloy for activation strips in magnetic anti-theft systems, the method comprising the following:
melting an alloy in a vacuum or a protective gas and its subsequent casting into an ingot, the alloy consisting essentially of 5 to 15 wt % Ni, 0.5 to 8 wt % Mn, 0.2 to 4 wt % Cu, 0 to 2 wt % Al, 0 to 2 wt % Ti, the rest iron and up to 1% w/impurities, where 0.5 wt %<(Cu+Al+Ti)<<5 wt %,
hot-forming the ingot to form a strip at temperatures of between 800° C. and 1300° C.,
intermediate annealing the strip at a temperature above approx. 800° C.,
rapid cooling at a speed of at least 500K/min;
cold-forming to achieve a reduction in cross-section of approx. 90%,
intermediate annealing at a temperature of approx. 600° C. to 800° C.,
cold-forming to achieve a reduction in cross-section of at least 85%, and
tempering at a temperature of 350° C. to 550° C.

17. A method according to claim 15, further comprising: cutting up the strip.

18. A method according to claim 15, further comprising: cutting an activation strip to length from the strip.

19. A method for producing a display element for a magnetic anti-theft system comprising the following:
providing at least one elongated alarm strip consisting of an amorphous ferromagnetic alloy,
providing at least one elongated activation strip consisting of a semi-hard magnetic alloy according to claim 1,
arranging of at least one alarm strip on at least one activation strip to produce a display element.

20. A method according to claim 19, wherein the alarm strip and the activation strip of the display element are arranged in a housing.

21. A method according to claim 19, wherein the alarm strip and the activation strip of the display element are arranged in the packaging of a consumer object.
